(19) United States
(12) Patent Application Publication
(10) Pub. No.: US 2015/0324910 A1
(43) Pub. Date: Nov. 12, 2015

(54) Synthetic Series Derivative Contracts

(71) Applicant: Chicago Mercantile Exchange Inc., Chicago, IL (US)

(72) Inventors: John Labuszewski, Westmont, IL (US); Frederick Sturm, Chicago, IL (US); John Nyhoff, Darien, IL (US); James Boudreault, Palatine, IL (US); Jonathan Kronstein, Elmhurst, IL (US)

(73) Assignee: Chicago Mercantile Exchange Inc., Chicago, IL (US)

(21) Appl. No.: 14/272,620

(22) Filed: May 8, 2014

(51) Int. Cl. G06Q 40/04

(52) U.S. Cl. CPC G06Q 40/04

(57) ABSTRACT

A computer system may process data associated with synthetic series derivative contracts. Those contracts may be settled in cash to an imputed value of a fixed income security. This fixed income security may be coupon bearing. The imputed value of the fixed income security may be based on a calculated value of a series of interest-based derivative contracts. Both that series and the fixed income security may be hypothetical.

### BACKGROUND

Investors often trade in financial products that are based on interest rates. Such trades may be performed as a hedge against changes in market interest rates or for other reasons. Interest rate futures contracts, such as Eurodollar futures contracts traded through the Chicago Mercantile Exchange, are commonly used for such purposes. Parties will sometime buy or sell series or “strips” of such futures contracts having successive expiration dates so as to form longer term investments. Interest rate swaps are another product often used for hedging and other purposes. Although useful, these and other types of products have limitations and can be cumbersome to administer in certain applications.

### SUMMARY

This Summary is provided to introduce a selection of concepts in a simplified form that are further described below in the Detailed Description. This Summary is not intended to identify key features or essential features of the invention.

In at least some embodiments, a computer system may process data associated with synthetic series derivative contracts. Those contracts may be settled in cash to an imputed value of a fixed income security. This fixed income security may be coupon bearing. The imputed value of the fixed income security may be based on a calculated yield of a series of interest-based derivative contracts. Both that series and the fixed income security may be hypothetical.

In some embodiments, definitional data for a synthetic series derivative contract class may be accessed. The definitional data may comprise synthetic series data identifying constituent derivative contract classes having successive expiration times. The definitional data may also comprise synthetic fixed income security data defining a synthetic fixed income security. An effective yield may be determined, as of a valuation time, for a synthetic series of contracts conforming to the constituent derivative contract classes. An imputed value, corresponding to the effective yield as of the valuation time, may be calculated for the synthetic fixed income security. Data may be stored to update an account value based on the imputed value of the synthetic fixed income security.

Embodiments include, without limitation, methods for processing data associated with synthetic series derivative contracts, computer systems configured to perform such methods and non-transitory computer-readable media storing instructions executable by a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing trading systems and methods according to at least some embodiments.

FIGS. 2 and 3 are a flow charts showing operations performed by an exchange computer system according to some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made.

Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or other computer-readable data (e.g., information that may or may not be executable). Any suitable computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules and/or other data may be located in both local and remote computer storage media including memory storage devices.

### Exemplary Operating Environment

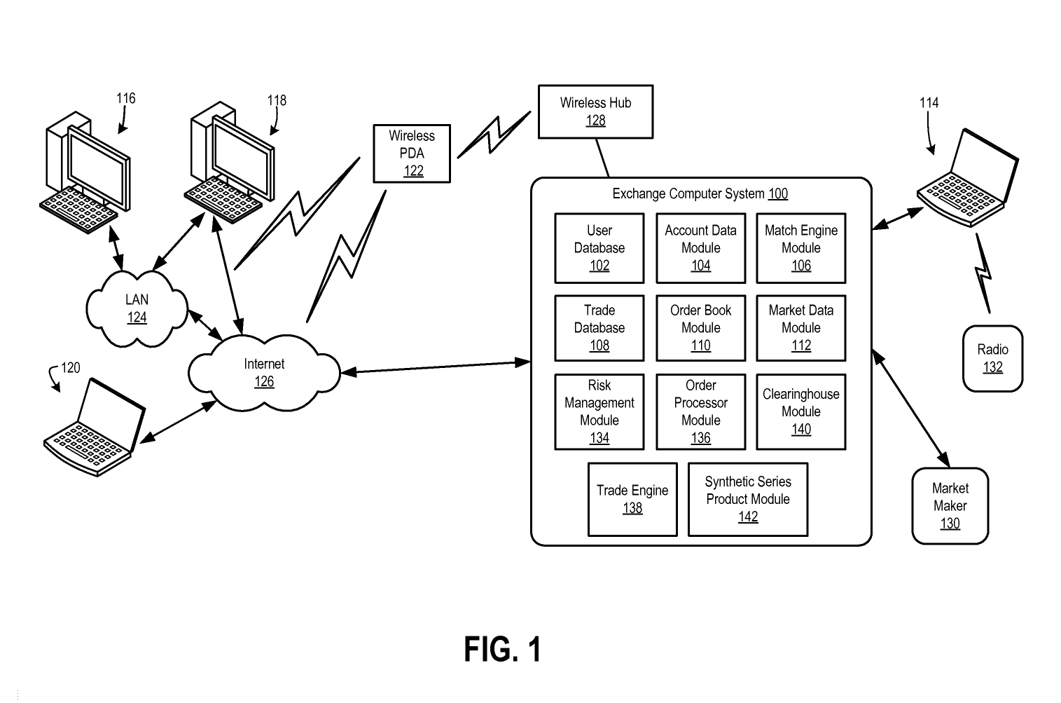

Aspects of at least some embodiments can be implemented with computer systems and computer networks that allow users to communicate trading information. An exemplary trading network environment for implementing systems and methods according to at least some embodiments is shown in FIG. 1. The implemented systems and methods can include systems and methods, such as are described herein, that facilitate data processing and other activities associated with synthetic series derivative contracts.

Exchange computer system 100 can be operated by an exchange (e.g., a financial product exchange or other type of exchange) and configured to perform operations of the exchange for, e.g., trading and otherwise processing various financial products. Financial products of the exchange may include, without limitation, futures contracts, options on futures contracts (“futures contract options”), other types of options, and other types of derivative contracts. For example, financial products traded or otherwise processed by the exchange may also include over-the-counter (OTC) derivative products such as OTC forwards, OTC options, etc. In at least some embodiments, and as explained in more detail below, financial products traded and/or otherwise processed through exchange computer system 100 include synthetic series derivative contracts such as those described herein.

Computer system 100 receives orders for financial products, matches orders to execute trades, transmits market data related to orders and trades to users, and performs other operations associated with an exchange. Computer system 100 may be implemented with one or more mainframe, desktop or other computers. In one embodiment, a computer device uses a 64-bit processor. A user database 102 includes information identifying traders and other users of computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of computer system 100 and configured to carry out operations of a clearinghouse of the exchange that operates computer system 100. Module 140 may receive data from and/or transmit data to trade database 108 and/or other modules of computer system 100, including synthetic series product module 142, regarding trades of futures contracts, futures contracts options, and other financial products traded through the exchange that operates computer system 100. Clearinghouse module 140 may facilitate the exchange (or a clearinghouse of the exchange) acting as one of the parties to every traded contract or other product. For example, computer system 100 may match an offer by party A to sell a futures contract or another exchange-traded financial product with a bid by party B to purchase a like exchange-traded financial product. Module 140 may then create an exchange-traded financial product between party A and the exchange clearinghouse and a second exchange-traded financial product between the exchange clearinghouse and party B. Module 140 may also be configured to perform other clearinghouse operations. As a further example, module 140 may maintain margin data with regard to clearing members and/or trading customers. As part of such margin-related operations, module 140 may store and maintain data regarding the values of various contracts and other instruments, determine mark-to-market and final settlement amounts, confirm receipt and/or payment of amounts due from margin accounts, confirm satisfaction of delivery and other final settlement obligations, etc.

Synthetic series product module 142 generates, stores and processes data regarding synthetic series derivative contracts. Various operations performed by synthetic series product module 142 in at least some embodiments are further described below. As also discussed below, operations associated with synthetic series derivative contracts may also and/or alternatively be performed by other modules of computer system 100.

Each of modules 102 through 142 could be implemented as separate software components executing within a single computer, separate hardware components (e.g., dedicated hardware devices) in a single computer, separate computers in a networked computer system, or any combination thereof (e.g., different computers in a networked system may execute software modules corresponding to more than one of modules 102-142). When one or more of modules 102 through 142 are implemented as separate computers in a networked environment, those computers may be part of a local area network, a wide area network, and/or multiple interconnected local and/or wide area networks.

Computer system 100 may also communicate in a variety of ways with devices that may be logically distinct from computer system 100. For example, computer device 114 is shown directly connected to computer system 100. Computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to computer system 100.

Computer devices 116 and 118 are coupled to a LAN 124 and may communicate with computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to computer system 100. Computer system 100 may also include trade engine 138. Trade engine 138 may, e.g., receive incoming communications from various channel partners and route those communications to one or more other modules of computer system 100.

One skilled in the art will appreciate that numerous additional computers and systems may be coupled to computer system 100. Such computers and systems may include, without limitation, additional clearing systems, regulatory systems and fee systems.

The operations of computer devices and systems shown in FIG. 1 may be controlled by computer-executable instructions stored on non-transitory computer-readable media. For example, computer device 116 may include computer-executable instructions for receiving market data from computer system 100 and displaying that information to a user. As another example, module 142 and/or other modules of computer system 100 may include computer-executable instructions for performing herein-described operations associated with synthetic series derivative contracts.

Of course, numerous additional servers, computers, handheld devices, personal digital assistants, telephones and other devices may also be connected to computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, a computer system may process data associated with synthetic series derivative contracts. Those contracts may be settled in cash to an imputed value of a fixed income security. The imputed value of that fixed income security may be based on a calculated yield value for a series of interest-based derivative contracts. Both that series and the fixed income security may be hypothetical.

Throughout this description, “contract” is distinguished from “contract class.” “Contract” refers to an agreement under which parties assume defined responsibilities. The parties may reach that agreement bilaterally or multilaterally through an exchange. “Contract class” (or “class of contracts”) refers to a category of contracts that have the same or similar terms. All contracts conforming to that class have those terms. Stated differently, an individual contract is an instance of the contract class that defines terms of that individual contact and of other like contracts.

In some embodiments, the synthetic series derivative contracts for which exchange computer system 100 receives, stores, generates and/or otherwise processes associated data may include synthetic series futures contracts. “Futures contract” is a generic term for certain types of derivative contracts. Futures contracts may be standardized contracts that are established by and traded through an exchange. Among other things, a futures contract class definition may specify a particular subject matter, or “underlying,” for all futures contracts conforming to the class. As but one example, an underlying may be an agricultural or other type commodity. In such a case, the futures contract class definition may further specify that each contract of the class requires delivery of a predefined amount of that commodity at a predefined future date. As yet another example, the underlying may be a currency, a market index, an interest rate or other economic subject matter. In such a case, the futures contract class definition may specify payment on a predefined date of an amount computed from the value of the underlying on some future date. In many cases, a futures contract class definition defines all terms of contracts in that class except for a price term. Parties wishing to enter into a futures contract may then submit orders that contain offer or bid values for that price term, with the orders then matched based on offer and bid values. Computer system 100 may then create corresponding contracts based on the matched orders.

There are two counterparties to a futures contract. A long counterparty (or “long”) usually refers to a futures contract party holding a long position, with that party also known as the buyer of the futures contract. For physically-settled futures contracts, a long may agree to pay a contract price in return for physical delivery of a contract underlying (e.g., a commodity) on a future date. A short counterparty (or “short”) usually refers to a futures contract party holding a short position, with that party also known as a seller of the futures contract. For physically-settled futures contracts, a short may agree to receive a contract price in return for providing physical delivery of the contract underlying on the future date.

Some types of futures contracts are financially settled by cash payment at contract expiration. For example, a futures contract may have a deliverable that represents a payment at a future time, with that payment representing the value of some underlying. For some classes of futures contracts, that underlying may be interest on a contractually-specified amount of a particular currency. For example, counterparties to an interest-based futures contract may agree that they will pay (or receive) interest on a notional amount. When entering into the contract, the counterparties may negotiate an interest rate as the contract price. At expiration, that contract price may be compared to a prevailing market rate. The difference between the contract price and the prevailing market rate is then applied to the notional amount. One of the counterparties then pays based on that difference and the other of the counterparties receives payment based that difference.

Eurodollars futures contracts, which are traded through the Chicago Mercantile Exchange, operate in this manner. The underlying for a Eurodollars futures contract is interest on a notional amount ($1,000,000) that will theoretically be placed on deposit for a three month period commencing at contract expiration. The contract price of a Eurodollars futures contract is an interest rate. A “buyer” of a Eurodollars futures contract is analogous to a lender or depositor of the notional amount, although such a loan or deposit is not actually made. The buyer agrees to receive or pay interest on the notional amount at contract expiration. The interest rate to be received or paid is based on the contract price and on a market rate prevailing at contract expiration. That market rate is the London Interbank Offered Rate (LIBOR). When a Eurodollar futures contract is settled at expiration, a difference between the contract price and the prevailing LIBOR is determined. If the difference is positive (i.e., the prevailing LIBOR is less than the contract price), the buyer would theoretically earn more on a 3-month deposit of the notional amount at the contract price than the buyer would earn on a 3-month deposit of the notional amount at the prevailing LIBOR. In this case, an account balance of the buyer is adjusted so that the buyer will have received, as a net of the final settlement and any previous mark-to-market settlements (described below), an amount equal to that difference multiplied by the notional amount. If the difference is negative (i.e., the prevailing LIBOR is more than the contract price), the buyer would theoretically earn less on a 3-month deposit of the notional amount at the contract price than the buyer would earn on a 3-month deposit of the notional amount at the prevailing LIBOR. In this case, the account balance of the buyer is adjusted so that the buyer will have ultimately paid an amount equal to that difference multiplied by the notional amount.

The reverse occurs for a “seller” of a Eurodollars futures contract. That seller is analogous to a borrower of the notional amount. Again, such a loan does not actually occur. If the difference between the contract price and the prevailing LIBOR is positive (prevailing LIBOR less than the contract price), the seller would theoretically pay more for accepting a deposit of the notional amount at the contract price than the seller would pay for accepting a deposit of the notional amount at the prevailing LIBOR. In this case, an account balance of the seller is adjusted so that the buyer will have ultimately paid an amount equal to that difference multiplied by the notional amount. If the difference between the contract price and the prevailing LIBOR is negative (prevailing LIBOR more than the contract price), the seller would theoretically pay less for accepting a deposit of the notional amount at the contract price than the seller would pay for accepting a deposit of the notional amount at the prevailing LIBOR. In this case, an account balance of the seller is adjusted so that the buyer will have ultimately received an amount equal to that difference multiplied by the notional amount.

Eurodollars futures contract prices indicate where the market believes that 90-day short term interest rates will be at some time in the future. For example, on March 1, year Y, Eurodollars futures contracts expiring on March 15, year Y+1, may be trading at a price P. That price P represents what the market believes, as of May 1, year Y, the 90-day LIBOR will be on March 15, year Y+1. Interest rate swaps are frequently priced against the LIBOR. Because of this, Eurodollars futures are often used to price interest rate swaps and to hedge risk of interest rate swaps.

A Eurodollars futures contracts may be traded in “strips.” A strip of Eurodollars futures contracts is a series of successively deferred quarterly Eurodollars futures contracts. In particular, the contracts in a strip have successive expiration dates. A strip may be used to create a long term investment. For example, prior to September 19 of year Y1, a party may buy (or sell) the Eurodollar futures contracts shown in Table 1. In Table 1 and in subsequent examples, “Y1” is a first year, “Y2” is the year following Y1 and “Y3” is the year following Y2.

TABLE 1

| contract | expiration |
|---|---|
| EDUY1 | 19 Sept. Y1 |
| EDZY1 | 19 Dec. Y1 |
| EDHY2 | 19 Mar. Y2 |
| EDMY2 | 19 June Y2 |
| EDUY2 | 19 Sept. Y2 |
| EDZY2 | 19 Dec. Y2 |
| EDHY3 | 19 Mar. Y3 |
| EDMY3 | 19 June Y3 |

An effective yield on a strip may be calculated as the compounded value of each successive quarterly investment in the strip. In particular, this calculation may assume that, on expiration of each contract in the strip (except for the last contract), the principle and interest of that contract are reinvested as the principle for the next contract. This is further illustrated using Table 2.

TABLE 2

| | day span | cumulative | | compounded | |
|---|---|---|---|---|---|
| contract | (DS) | term (T) | rate (r) | value (CV) | yield (Y) |
| EDUY1 | 91 | 91 | .3725% | 1.00094 | .37250% |
| EDZY1 | 91 | 182 | .5300% | 1.00228 | .45150% |
| EDHY2 | 91 | 273 | .5150% | 1.00359 | .47306% |
| EDMY2 | 91 | 364 | .4900% | 1.00483 | .47773% |
| EDUY2 | 91 | 455 | .4900% | 1.00608 | .48066% |
| EDZY2 | 91 | 546 | .5100% | 1.00737 | .48607% |
| EDHY3 | 91 | 637 | .5300% | 1.00872 | .49290% |
| EDMY3 | 91 | 728 | .6050% | 1.01026 | .50757% |

In Table 2, “day span” refers to the deposit period associated with a Eurodollar futures contract on a particular row. “Cumulative term” refers to the cumulative deposit period of a Eurodollar futures contract on a row and of Eurodollars futures contracts in preceding rows. “Rate” refers to an annualized interest rate associated with the day span of the Eurodollar futures contract on a particular row. This rate may be determined in different ways at different times. If the holder of the contracts in Table 2 separately entered into each of those contracts, the rates at the time of entering the contracts may be contract prices that resulted from matches with other parties' bids or offers. If the contracts in Table 2 were entered as a strip through a single transaction with an exchange, the rates at the time of entering the contracts may be determined based on a contract price for the strip and an algorithm employed by the exchange. After entering the contracts in Table 2, and prior to expiration, the values for the rate of one of the contracts may be based on prices of like contracts trading at the time the rate is determined. After a contract expires, the rate may be the LIBOR as of the expiration. As is known in the art, Eurodollars futures contracts are quoted as 100−(annualized rate). For example, the rate of contract EDUY1 would be quoted as 99.6275. For simplicity, actual annualized rates are used in the above chart and in descriptions herein.

Table 2 assumes an initial investment of $1 in contract EDUY1 that is subsequently reinvested, with accrued interest, in each of the other contracts in the strip. Table 2 also assumes that each of years Y1-Y3 is 360 days. The compounded value CV of the investment at expiration of EDUY1 is $1+[r*(DS/360)]$1, i.e., $1+[0.003725*(91/360)]*$1, or $1.0009416. The strip yield Y at expiration of EDUY1 is [(CV−$1)*360/CT], or 0.3725%. This $1.00094 is then reinvested in EDZY1, resulting in a compounded value CV at EDZY1 expiration of $1.0009416+0.005300*(91/360)*$1.0009416, or $1.0022826, and a strip yield Y of [($1.0022826−$1)*360/182], or 0.45150%. A similar procedure can be used to calculate the compounded value CV and yield Y at expiration of the remaining contracts in the strip. Equation 1 below is a formula for calculating the effective yield Y of a strip of n quarterly interest-based futures contracts such as in Table 2, assuming a $1 initial investment.

$$Y ( n ) = ( {{\prod }_{i = 1}}^{n} [ 1 + r ( i ) ⋆ ( \frac{DS ( i )}{360} ) - 1 ) \div ( \frac{T ( n )}{360} ) \qquad Equation 1$$

In Equation 1, Y(n) is the effective yield for the strip of n contracts (e.g., n=8 in the example of Table 2), i is a counter for contracts in the strip up to and including the n^{th} contract, DS(i) is the day span of the i^{th} contract in the strip, r(i) is the rate for the DS(i) period associated with the i^{th} contract in the strip, and T(n) is the cumulative term for the n^{th} contract and all preceding contracts in the strip.

Bonds, notes or other types of fixed income securities pay interest on a principal amount. A fixed income security may have a face value, a coupon interest rate that is payable at defined coupon payment times, a maturity date on which the fixed income security face value is to be repaid, and other familiar terms. The actual yield of a fixed income security depends on those terms and on the price that is initially paid for the fixed income security. In general, increasing a fixed income security purchase price lowers the yield.

The effective yield of a Eurodollar strip (or of another series of derivative contracts) can be used to impute a value to a fixed income security. In particular, it is possible to determine the price that would be paid for a fixed income security having specified terms so as to achieve that same effective yield. Numerous formulas are available to perform this calculation. One example of such a formula is shown in Equation 2.

$$SP = \frac{C}{Y} ( 1 - ( \frac{1}{{( 1 + ( Y \text{/} 2 ) )}^{2 M}} ) ) + ( \frac{FV}{{( 1 + ( Y \text{/} 2 ) )}^{2 M}} ) \qquad Equation 2$$

In Equation 2, SP is the price paid for a fixed income security to achieve an effective yield Y. The value C represents the value of annual coupon payments. The value M is the term of the fixed income security in years. The value FV is the face value for the fixed income security.

As an example, assume that a fixed income security is to be purchased on June 19 of year Y1. Further assume that the fixed income security has a 2-year maturity, a face value (or par) of $1 and a 6% semiannual coupon (i.e., 3% interest on the face value is paid semiannually). The purchase price of such a fixed income security on June 19, Y1, to achieve a 0.50757% yield would be $1.1091622, or 110.91622% of par.

Numerous other formulas are known for calculating the price that must be paid for a fixed income security to achieve a designated yield. Some of those formulas account for variations in coupon payment dates, timing of fixed income security settlement (e.g., if a fixed income security is acquired once a coupon period has begun and/or after one or more coupon payments have been made), etc. One example of such a formula is used in the “PRICE” function in the EXCEL spreadsheet software available from Microsoft Corporation.

In at least some embodiments, computer system 100 receives, stores, generates and/or otherwise processes data associated with synthetic series futures contracts. The underlying for those contracts may be a price of a hypothetical fixed income security that results in a yield equivalent to a yield on a series of interest rate derivative contracts (e.g., a series of Eurodollar futures contracts). The class definition for the synthetic series futures contracts may define the parameters of the hypothetical fixed income security. Those parameters (e.g., coupon rate, coupon timing, face value, settlement date, maturity date, etc.) may or may not be the same as the terms of bonds or other fixed income securities that are actually traded.

A class definition for the synthetic series futures contracts may also define classes of interest rate derivative contracts. At various times, an effective yield may be calculated for a series of interest rate derivative contracts conforming to those classes, and that effective yield then used to impute a value to the hypothetical fixed income security. Those classes of interest rate derivative contracts may be classes of contracts that are separately traded. A strip of such contracts is not actually traded as part of a synthetic series futures contract, however. Accordingly, a hypothetical series of those interest rate contracts is considered “synthetic” for purposes of a synthetic series futures contract.

For convenience, the following terminology is used when describing a class of synthetic series derivative contracts. Classes of futures contracts from which a synthetic series is created will be called the “series constituent classes” or “series constituents.” “Constituent fixed income security” will refer to a hypothetical fixed income security that will be valued based on a yield of the synthetic series.

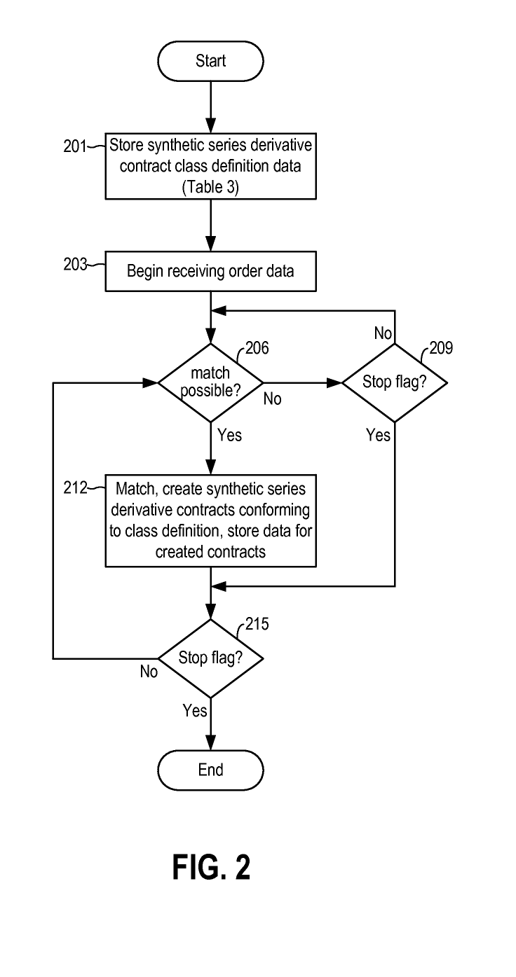

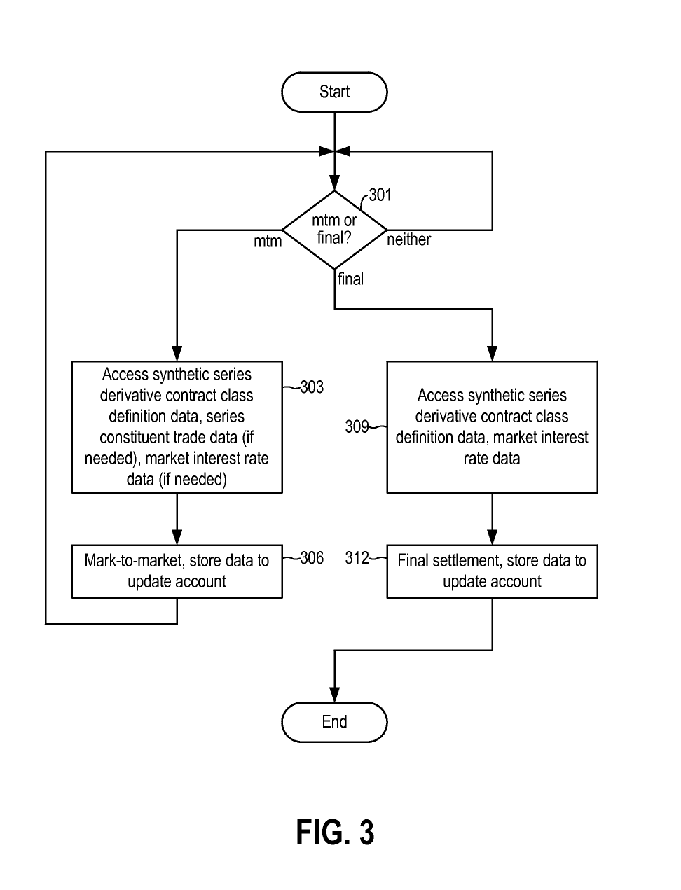

FIGS. 2 and 3 are flow charts showing operations performed in some embodiments to process data associated with synthetic series futures contracts. Although the below description may refer to performance of these operations by specific modules of computer system 100, in other embodiments one or more of such operations may be performed by different modules and/or by a computer system that is not an exchange computer system. To simplify explanation, the operations of FIGS. 2 and 3 are described using a single hypothetical class of synthetic series futures contracts. In particular, a hypothetical “SS1 futures” class is used as an example. A futures contract conforming to the SS1 futures class definition will be referred to simply as an “SS1 contract.”

FIG. 2 shows operations performed by computer system 100 in connection establishing the SS1 futures class and in connection with creation of SS1 contracts. In step 201 of FIG. 2, synthetic series product module 142 stores SS1 futures class definition data. Included in that data 201 is data indicating values for each of multiple parameters, with each of those parameters corresponding to a term applicable to all SS1 contracts. Computer system 100 may simultaneously create and store data defining numerous other synthetic series derivative contract classes. Computer system 100 may also perform operations, such as those described herein, with regard to contracts of those other classes while it is performing such operations with regard to SS1 contracts. Table 3 summarizes a portion of the definitional data stored in step 201.

TABLE 3

| Data type | Description |
|---|---|
| series | IRFC1, IRFC2, . . . IRFCn |
| FIS | face value |
| FIS | coupon rate |
| FIS | coupon date 1 , coupon date 2, . . . coupon date k |
| FIS | maturity date |
| FIS | time basis |
| FIS | fixed income security settlement date |
| transaction | quote convention |
| transaction | tick minimum |
| transaction | settlement methodology (mtm) |
| transaction | settlement methodology (final) |
| transaction | time and date trading for SS1 contracts opens |
| transaction | time and date trading for SS1 contracts closes |

The definitional data includes several categories. “Series” data identifies classes of interest rate futures contracts that serve as the series constituent classes for the SS1 futures class. In the present example, the series constituents are represented generically as IRFC1, IRFC2, . . . IRFCn, where “n” is the total number of constituent classes. Each of the series constituents is a class of derivative contracts based on an interest rate. Those classes may represent contracts that expire on successive dates (e.g., IFC2 contracts expire after IFC1 contracts, IFC3 contracts expire after IFC2 contracts, etc.), but that may otherwise be identical. The series constituents may be classes of futures contracts that are separately traded and for which computer system 100 also performs data processing operations. The series definitional data may include pointers to other data stored by computer system 100 that define the terms of each series constituent class (e.g., underlying, notional amount, expiration date, etc.). The latest expiration of the series constituent classes may be the expiration date for the SS1 futures class. In one example embodiment, IRFC1 could be a class of EDUY1 Eurodollar futures contracts, IRFC2 could be a class of EDZY1 Eurodollar futures contracts, IRFC3 could be a class of EDHY2 Eurodollar futures contracts, IRFC4 could be a class of EDMY2 Eurodollar futures contracts, IRFC5 could be a class of EDUY2 Eurodollar futures contracts, IRFC6 could be a class of EDZY2 Eurodollar futures contracts, IRFC7 could be a class of EDHY3 Eurodollar futures contracts and IRFCn=IRFC8 could be a class of EDMY3 Eurodollar futures contracts.

The “FIS” data identifies terms for the constituent fixed income security. Those terms include a face (or “par”) value for that constituent fixed income security, a coupon interest rate for that fixed income security, the method by which that coupon interest rate is applied to a hypothetical coupon payment (e.g., (coupon rate)*(face value)/(number of coupon payments per year)) and hypothetical coupon payment dates 1 through k, where k is the total number of hypothetical coupon payments. The constituent fixed income security terms also include a maturity date on which the face value would hypothetically be repaid and a time basis for fixed income security calculations (e.g., 360-day vs. 365-day year, etc.). The constituent fixed income security terms further include a fixed income security settlement date. That date may represent the date used in Equation 2 or other known formula when imputing a value to the constituent fixed income security. The fixed income security settlement date may be, e.g., a date that precedes the earliest expiration date of the series constituent classes.

The “transaction” data may further define how SS1 contracts may be quoted, traded and settled. For example, the transaction data may define a quote convention. The transaction data may also define a methodology for interim settlements for purposes of marking to market (described below) and a methodology for final contract settlement. The transaction data may further define a minimum tick size, i.e., the minimum pricing increment for use in offer and bid orders, a time and date when trading in SS1 contracts opens and a time and date when trading in SS1 contracts closes.

In step 203, order book module 110 of exchange computer system 100 begins receiving order data from parties desiring to enter into SS1 contracts. Computer system 100 may continue to receive such order data until the operations of FIG. 2 end. The received order data includes buy order data from parties wishing to buy (i.e., acquire long positions in) SS1 contracts and sell order data from parties wishing to sell (i.e., acquire shorts positions in) SS1 contracts. The buy order data includes bid pricing data indicating contract prices at which the submitters are willing to buy SS1 contracts. The sell order data includes offer pricing data indicating contract prices at which the submitters are willing to sell SS1 contracts. In at least some embodiments, buy and sell orders are quoted as a price for the constituent fixed income security. In other embodiments, buy and sell orders may be quoted as a percentage of the constituent fixed income security par value.

In step 206, match engine module 106 of computer system 100 determines if any of the received buy orders can be matched with any of the received sell orders. Match engine module 106 may perform this determination based on the bid and offer prices in those orders. This matching may be performed on a first-in first-out (FIFO) basis or on some other basis and using conventional order matching algorithms used in connection with order for existing types of futures contracts. If no matches are possible, and as shown by the “no” branch from step 206, computer system 100 determines in step 209 whether a “stop” flag has been set. Such a flag may be set, for example, if the close of trading time and date for the SS1 futures class has been reached. If the flag is not set, and as shown by the “no” branch from step 209, step 206 is repeated. If the stop flag has been set, and as shown by the “yes” branch from step 209, the operations of FIG. 2 end.

If computer system 100 determines in step 206 that a match is possible, and as shown by the yes branch from step 206, the match is performed in step 212. As part of step 212, computer system 100 stores data creating SS1 contracts corresponding to the matched buy and sell orders. For each SS1 contract buy order matched to an SS1 contract sell order, at least two SS1 contracts are created. A first of those SS1 contracts is between the matched buyer and a clearinghouse of the exchange. The buyer is the long counterparty to that SS1 contract and the clearinghouse is the short counterparty to that contract. A second of those SS1 contracts is between the matched seller and the clearinghouse. The seller is the short counterparty to that SS1 contract and the clearinghouse is the long counterparty to that contract. The prices for those two SS1 contracts, which are based on the matched orders, are the same and establish the initial value of those contracts. The matched buyer and seller may not know each other's identities. As part of step 212, clearinghouse module 140 of computer system 100 stores the contract price as the initial value for each of the just-created SS1 contracts.

In step 215, computer system 100 again determines if the stop flag has been set. If not, and as indicated by the “no” branch from step 215, computer system 100 returns to step 206. If the stop flag has been set, and as indicated by the “yes” branch from step 215, the operations of FIG. 2 end.

FIG. 3 shows operations performed by computer system 100 in connection with each SS1 contract that results from a match in step 212 of FIG. 2. Computer system 100 may simultaneously perform operations of FIG. 3 in numerous independent program threads, with each thread corresponding to a matched pair of buy and sell orders. For example, if a buy order for one SS1 contract is matched with a sell order for one SS1 contract, computer system 100 may perform the operations of FIG. 3 in one program thread in connection with an account of the buy order submitter and separately perform the operations of FIG. 3 in another program thread in connection with an account of the sell order submitter. For convenience, the operations of FIG. 3 will be described in the context of a single contract. In some cases, however a single order matching may result in numerous pairs of contracts. For example, a buy order for 500 SS1 contracts might be matched against a sell order for 500 SS1 contracts. In such a case, computer system 100 might perform the operations of FIG. 3 in one program thread for the resulting 500 SS1 contract long positions of the buy order submitter and separately perform the operations of FIG. 3 in another program thread for the resulting 500 SS1 contract short positions of the sell order submitter.

Prior to the expiration of SS1 contracts, exchange computer system 100 may track the values of those SS1 contracts and periodically adjust the accounts of counterparties to those contracts based on changes in contract value. This operation, known as marking to market, is similar to known mark-to-market operations performed in connection with other types of futures contracts. For example, P may be a contract price for first and second SS1 contracts resulting from a match of a buy order from a first party and a sell order from a second party. At a subsequent time, the value of an SS1 contract may change by ΔP. As a result of that change, the accounts of the first and second parties may be updated to reflect the changed value. If ΔP is positive and the price of SS1 contracts has increased, the first party's account would be adjusted to indicate that the first party's long SS1 contract interest has a new value of P+ΔP. The second party's account would be adjusted to indicate that the second party's short SS1 contract interest has a new value of P-ΔP. If ΔP is negative and the price of SS1 contracts has decreased, the reverse would occur (first party's account adjusted to indicate P-ΔP value, second party's account adjusted to indicate P+ΔP value).

In some embodiments, the expiration date of an SS1 contract may be the latest of the series constituent expiration dates. For example, if the series constituents are Eurodollar futures contract classes for the contracts shown in Tables 1 and 2, the expiration of the SS1 futures class may be 19 June Y3. In some such embodiments, computer system 100 may perform mark-to-market calculations in different manners at different times prior to SS1 contract expiration. For times prior to the earliest of the series constituent expiration dates (e.g., prior to 19 September Y1 if the series constituents are Eurodollar futures contract classes for the contracts shown in Tables 1 and 2), changes in contract value may be calculated based on subsequent trading prices for SS1 contracts. For example, the contract price and initial value for an SS1 contract may be P. On a subsequent trading day, the closing price for SS1 contracts may change by ΔP.

For times after the earliest of the series constituent expiration dates and prior to expiration of an SS1 contract, the value of that SS1 contract may be calculated using final settlement data for any of the series constituents that have expired and recent trading prices for series constituents that have not yet expired. For example, assume that the series constituents for the SS1 futures class are Eurodollar futures contract classes for the contracts shown in Tables 1 and 2. Further assume that a mark-to-market calculation is being performed on 1 May Y2. An effective yield for the synthetic series as of 1 May Y2 would first be calculated using the methodology described in connection with Table 2 or using Equation 1. This 1 May Y2 value of effective yield would reflect actual LIBOR rates for series constituents that have expired as of 1 May Y2 (EDUY1, EDZY1, and EDHY2) and market estimates of LIBOR rates for constituents that have not yet expired as of 1 May Y2 (EDMY2, EDUY2, EDZY2, EDHY3 and EDMY3). In particular, the calculation of 1 May Y2 effective yield will use the values of the LIBOR on 19 September Y1, 19 December Y1 and 19 March Y2 as the rates (r) for the day spans (DS) associated with the EDUY1, EDZY1 and EDHY2 classes, respectively. The calculation will use the trading prices on 1 May Y2 for EDMY2, EDUY2, EDZY2, EDHY3 and EDMY3 futures contracts as the rates (r) for the day spans (DS) associated with the EDMY2, EDUY2, EDZY2, EDHY3 and EDMY3 classes, respectively. The 1 May Y2 effective yield for the synthetic strip would then be used to calculate the purchase price of the constituent fixed income security to achieve that same yield. This calculation of constituent fixed income security value would assume the same fixed income security settlement date specified by the SS1 futures class definition data. The fixed income security purchase price could be calculated using a formula such as Equation 2 or other known formula and the constituent fixed income security definition data for the SS1 futures class. The calculated fixed income security purchase price could then be used to determine a change in SS1 contract value relative to a previous value determination (e.g., for 30 April Y2 in the present example).

At expiration of SS1 contracts, a final settlement value can be calculated using a similar methodology. For example, assume again that the series constituents for the SS1 futures class are Eurodollar futures contract classes for the contracts shown in Tables 1 and 2. At final settlement, a final effective yield of the synthetic series would be calculated using the methodology described in connection with Table 2 or Equation 1. However, the values of rates (r) for the DS periods associated with the EDUY1, EDZY1, EDHY2, EDMY2, EDUY2, EDZY2, EDHY3 and EDMY3 classes would be, respectively, the values of the LIBOR on 19 September Y1, 19 December Y1 and 19 March Y2, 19 June Y2, 19 September Y2, 19 December Y2, 19 March Y3 and 19 June Y3. The final effective yield would then be used to calculate the purchase price of the constituent fixed income security using a formula such as Equation 2 or other known formula and the constituent fixed income security definition data for the SS1 futures class.

In step 301 of FIG. 3, computer system 100 determines if it is time to perform a mark-to-market calculation or a final settlement calculation. If it is not time for either, and as indicated by the “neither” branch, computer system 100 repeats step 301. If it is time to perform a mark-to-market calculation, and as indicated by the “mtm” branch, computer system 100 proceeds to step 303 and accesses SS1 futures class definition data. Computer system 100 also accesses data, as appropriate, for recent SS1 contract trade prices, recent series constituent trade prices, and/or LIBOR values for any series constituents that have expired. Computer system 100 then proceeds to step 306 and performs mark-to-market calculations based on the data accessed in step 303. These mark-to-market calculations may include determining an effective yield for the synthetic series and calculating an imputed value for the constituent fixed income security, as previously described. As part of step 306, computer system 100 also stores data to update an account of the holder of the SS1 contract to reflect the changed contract value. As with marking-to-market performed in connection with other types of futures contracts, this update may represent an account decrease that requires the holder to deposit additional funds or may represent an account increase that the holder can withdraw.

After step 306, computer system 100 returns to step 301. If computer system 100 determines in step 301 that it is time to perform a final settlement calculation, and as indicated by the “final” branch from step 301, computer system 100 proceeds to step 309 and accesses SS1 futures class definition data. Computer system 100 also accesses data for LIBOR values for the series constituents. Computer system 100 then proceeds to step 312 and performs final settlement calculations based on the data accessed in step 309. These calculations may include determining an effective yield for the synthetic series and calculating an imputed value for the constituent fixed income security, as previously described. As part of step 312, computer system 100 also stores data to update an account for the holder of the SS1 contract to reflect the final contract value. As with final settlement performed in connection with other types of futures contracts, this update may represent an account decrease that requires the holder to deposit additional funds or may represent an account increase that the holder can withdraw.

In some embodiments, mark-to-market calculations for times prior to the earliest series constituent expiration are performed based on trade prices for the series constituents instead of trade prices for other SS1 contracts. For example, assume once again that the series constituents for the SS1 futures class are Eurodollar futures contract classes for the contracts shown in Tables 1 and 2. For a mark-to-market prior to expiration of the EDUY1 class, an effective yield of the synthetic series would be calculated using the methodology described in connection with Table 2 or Equation 1. The values of rates (r) for the DS periods associated with the EDUY1, EDZY1, EDHY2, EDMY2, EDUY2, EDZY2, EDHY3 and EDMY3 classes would be the trade prices for contracts of those classes as of the mark-to-market date. The effective yield would then be used to calculate the purchase price of the constituent fixed income security using a formula such as Equation 2 or other known formula and the constituent fixed income security definition data for the SS1 futures class.

In some embodiments, a synthetic series futures contract class may have a two year term and define a synthetic bond that has a $200,000 face value and a two year term. That class may further define minimum quote increments of ¼ of 1/32 of 1% of the $200,000 face value (i.e., $15,625) so as to correspond to a class definition for a U.S. Treasury futures contract (e.g., the two-year Treasury note futures contracts traded through the Chicago Board of Trade).

In some embodiments, a synthetic series futures contract class may have a five year term and define a synthetic bond that has a $100,000 face value and a five year term. That class may further define minimum quote increments of ½ of 1/32 of 1% of the $100,000 face value (i.e., $15,625) so as to correspond to a class definition for a U.S. Treasury futures contract (e.g., the five-year Treasury note futures contracts traded through the Chicago Board of Trade).

Although examples thus far have described synthetic series futures contracts and classes thereof, additional embodiments include other types of synthetic series derivative contracts. For example, a synthetic series derivative contract could be an OTC instrument bilaterally negotiated between parties instead of multilaterally traded through an exchange.

Synthetic series derivative contracts such as described herein offer several advantages over existing products. A synthetic series derivative contract mimics risk associated with an actual strip of interest-based futures contracts, but is more convenient to trade. A synthetic series derivative contract may also mimic the behavior of many types of interest rate swaps, but does not require periodic interest payments or impose other administrative burdens often associated with an interest rate swap. To better mimic interest rate swaps, a synthetic series derivative class may be defined so that the coupon rate associated with the synthetic fixed income security is commensurate with values of interest rate swaps being traded during the period that synthetic series derivative contracts of that class may be traded.

Synthetic series derivative contracts such as described herein may facilitate spread trading relative to existing types of Treasury futures contracts. For example, a synthetic series futures contract based on a synthetic series of Eurodollar futures contracts facilitates the execution of a “TED” (Treasury vs. Eurodollar) spread. TED spreads are a reflection of private credit risks, as represented in Eurodollar futures, vs. public credit risks, as reflected in U.S. Treasury futures. Currently, TED spreads may be constructed by taking offsetting positions in spot Treasury securities or Treasury futures vs. an opposite position in strips of Eurodollar futures. But while there is much interest in trading TED spreads, they remain difficult to construct and quote to the extent that Treasury and Eurodollar futures are quoted in fundamentally incompatible ways. Treasury futures are typically quoted in percent of par in minimum increments of some fraction of 1% of par, while Eurodollar futures are quoted by reference to 100 minus the yield. Traders must make many mathematical transformations in order to compare the value of a Treasury futures contract relative to a strip of Eurodollar futures contracts. The need to perform these calculations can impede the efficiency of TED spread trading.

In at least some embodiments, a synthetic series derivative contract transforms the value implied in a strip of Eurodollar futures into a value that is compatible with standard quotation practices in Treasury markets. This facilitates TED spread activity or spreading of Eurodollar strips vs. other fixed income securities that are also quoted in percent of par. Those other fixed income securities include agency securities, corporate bonds, municipal bonds, mortgage backed securities (MBS), asset backed securities (ABS) and other items.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
accessing, by an exchange computer system, definitional data for a synthetic series derivative contract class, wherein the definitional data comprises
synthetic series data identifying constituent derivative contract classes having successive expiration times and
synthetic fixed income security data defining a synthetic fixed income security;
determining, by the exchange computer system, an effective yield as of a valuation time for a synthetic series of contracts conforming to the constituent derivative contract classes;
calculating, by the exchange computer system, an imputed value of the synthetic fixed income security corresponding to the effective yield as of the valuation time; and
storing, by the exchange computer system and with regard to a synthetic series derivative contract conforming to the synthetic series derivative contract class, data updating an account value based on the imputed value of the synthetic fixed income security.

2. The method of claim 1, further comprising:
receiving, at the exchange computer system, buy order data representing a bid price for a contract conforming to the synthetic series derivative contract class and sell order data representing an offer price for a contract conforming to the synthetic series derivative contract class;
matching, by the exchange computer system, the buy order data and the sell order data; and
storing, by the exchange computer system and as a result of the matching, data creating the synthetic series derivative contract.

3. The method of claim 1, wherein each of the constituent derivative contract classes defines a class of futures contracts requiring payment based on an interest rate common to all contracts conforming to the constituent derivative contract class and on a notional amount common to all contracts conforming to the constituent derivative contract class.

4. The method of claim 1, wherein, for each of the constituent derivative contract classes,
the class defines a class of derivative contracts requiring payment based on an interest rate difference applied a notional amount,
the notional amount is common to all contracts conforming to the class, and
the interest rate difference comprises a difference between a contract price for a contract conforming to the class and a market interest rate.

5. The method of claim 1, wherein each of the constituent derivative contract classes is a different class of Eurodollar futures contracts.

6. The method of claim 1, wherein the synthetic fixed income security data defines a settlement date for the synthetic fixed income security prior to a first expiration date of the constituent derivative contract classes.

7. One or more non-transitory computer-readable media storing computer executable instructions that, when executed, cause a computer system to perform operations that include:
accessing definitional data for a synthetic series derivative contract class, wherein the definitional data comprises
synthetic series data identifying constituent derivative contract classes having successive expiration times and
synthetic fixed income security data defining a synthetic fixed income security;
determining an effective yield as of a valuation time for a synthetic series of contracts conforming to the constituent derivative contract classes;
calculating an imputed value of the synthetic fixed income security corresponding to the effective yield as of the valuation time; and
storing, with regard to a synthetic series derivative contract conforming to the synthetic series derivative contract class, data updating an account value based on the imputed value of the synthetic fixed income security.

8. The one or more non-transitory computer-readable media of claim 7, further comprising stored computer executable instructions that, when executed, cause a computer system to perform operations that include:
receiving buy order data representing a bid price for a contract conforming to the synthetic series derivative contract class and sell order data representing an offer price for a contract conforming to the synthetic series derivative contract class;
matching the buy order data and the sell order data; and
storing, as a result of the matching, data creating the synthetic series derivative contract.

9. The one or more non-transitory computer-readable media of claim 7, wherein each of the constituent derivative contract classes defines a class of futures contracts requiring payment based on an interest rate common to all contracts conforming to the constituent derivative contract class and on a notional amount common to all contracts conforming to the constituent derivative contract class.

10. The one or more non-transitory computer-readable media of claim 7, wherein, for each of the constituent derivative contract classes,
the class defines a class of derivative contracts requiring payment based on an interest rate difference applied a notional amount,
the notional amount is common to all contracts conforming to the class, and
the interest rate difference comprises a difference between a contract price for a contract conforming to the class and a market interest rate.

11. The one or more non-transitory computer-readable media of claim 7, wherein each of the constituent derivative contract classes is a different class of Eurodollar futures contracts.

12. The one or more non-transitory computer-readable media of claim 7, wherein the synthetic fixed income security data defines a settlement date for the synthetic fixed income security prior to a first expiration date of the constituent derivative contract classes.

13. A computer system comprising:
at least one processor; and
at least one non-transitory memory, wherein the at least one non-transitory memory stores instructions that, when executed, cause the computer system to perform operations that include
accessing definitional data for a synthetic series derivative contract class, wherein the definitional data comprises
synthetic series data identifying constituent derivative contract classes having successive expiration times and
synthetic fixed income security data defining a synthetic fixed income security,
determining an effective yield as of a valuation time for a synthetic series of contracts conforming to the constituent derivative contract classes,
calculating an imputed value of the synthetic fixed income security corresponding to the effective yield as of the valuation time, and
storing, with regard to a synthetic series derivative contract conforming to the synthetic series derivative contract class, data updating an account value based on the imputed value of the synthetic fixed income security.

14. The computer system of claim 13, wherein the at least one non-transitory memory stores instructions that, when executed, cause the computer system to perform operations that include
receiving buy order data representing a bid price for a contract conforming to the synthetic series derivative contract class and sell order data representing an offer price for a contract conforming to the synthetic series derivative contract class,
matching the buy order data and the sell order data, and
storing, as a result of the matching, data creating the synthetic series derivative contract.

15. The computer system of claim 13, wherein each of the constituent derivative contract classes defines a class of futures contracts requiring payment based on an interest rate common to all contracts conforming to the constituent derivative contract class and on a notional amount common to all contracts conforming to the constituent derivative contract class.

16. The computer system of claim 13, wherein, for each of the constituent derivative contract classes,
the class defines a class of derivative contracts requiring payment based on an interest rate difference applied a notional amount,
the notional amount is common to all contracts conforming to the class, and
the interest rate difference comprises a difference between a contract price for a contract conforming to the class and a market interest rate.

17. The computer system of claim 13, wherein each of the constituent derivative contract classes is a different class of Eurodollar futures contracts.

18. The computer system of claim 13, wherein the synthetic fixed income security data defines a settlement date for the synthetic fixed income security prior to a first expiration date of the constituent derivative contract classes.
